(19) United States
(12) Patent Application Publication
(10) Pub. No.: US 2021/0176971 A1
(43) Pub. Date: Jun. 17, 2021

(54) INVOLUNTARY GUIDANCE AND TRANSPORT SYSTEM FOR FISH

(71) Applicant: Regents of the University of Minnesota, Minneapolis, MN (US)

(72) Inventor: Przemyslaw Bajer, Minneapolis, MN (US)

(21) Appl. No.: 17/117,908

(22) Filed: Dec. 10, 2020

Related U.S. Application Data
(60) Provisional application No. 62/948,501, filed on Dec. 16, 2019.

(51) Int. Cl. A01K 61/95; A01K 79/02; A01K 69/04; E02B 8/08; E02B 1/00

(52) U.S. Cl. CPC A01K 61/95; A01K 79/02; E02B 1/006; E02B 8/085; A01K 69/04

(57) ABSTRACT

A system includes a fish stunner configured to stun fish within a stunning zone of a waterway and a conveyor with a portion of the conveyor located below a waterline of the waterway and a second portion of the conveyor located above the waterline such that fish that have been stunned reach the conveyor and are lifted out of the water by the conveyor.

### CROSS-REFERENCE TO RELATED APPLICATION

The present application is based on and claims the benefit of U.S. provisional patent application Ser. No. 62/948,501, filed Dec. 16, 2019, the content of which is hereby incorporated by reference in its entirety.

### BACKGROUND

Many species of fish exhibit seasonal migrations when large numbers of individuals migrate through streams and rivers. In many cases, these migrating fish are attempting to access their breeding grounds. In the case of native fish, management efforts often aim to facilitate these migrations, especially if migration routes are blocked by dams or other physical barriers. In the case of invasive fish, the goal is to block these migrations and remove the fish.

The discussion above is merely provided for general background information and is not intended to be used as an aid in determining the scope of the claimed subject matter. The claimed subject matter is not limited to implementations that solve any or all disadvantages noted in the background.

### SUMMARY

A system includes a fish stunner configured to stun fish within a stunning zone of a waterway and a conveyor with a portion of the conveyor located below a waterline of the waterway and a second portion of the conveyor located above the waterline such that fish that have been stunned reach the conveyor and are lifted out of the water by the conveyor. In accordance with a further embodiment, a method includes activating a fish stunner in a waterway to produce stunned and drifting fish and directing the stunned and drifting fish onto a conveyor that is at least partially in the waterway. The conveyor is then used to lift stunned fish out of the waterway.

In accordance with a still further embodiment, a system includes a fish holding area and a stunning device located in a waterway and a conveyor located relative to the stunning device such that stunned fish move with a current onto the conveyor.

In accordance with a still further embodiment, a fence for a waterway includes first and second lateral supports, each having a plurality of holes, and a plurality of posts. Each post passes through a respective hole of the plurality of holes of the first lateral support and a respective hole of the plurality of holes of the second lateral support such that each post moves through the post's respective holes independently of other posts of the plurality of posts.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a plan view of an involuntary guidance and transport system for fish in accordance with one embodiment.

FIG. 2 is a side view of a portion of the system of FIG. 1.

FIG. 3 is a plan view of an involuntary guidance and transport system for fish in accordance with a second embodiment.

FIG. 4 is a plan view of an involuntary guidance and transport system for fish in accordance with a third embodiment.

FIG. 5 is a plan view of an involuntary guidance and transport system for fish in accordance with a fourth embodiment.

FIG. 6 is a side view of two sections of a fence in accordance with one embodiment.

FIG. 7 is a top view of the two sections of fence of FIG. 6.

FIG. 8 is a top view of the two sections of fence of FIG. 6 in a different orientation relative to each other.

FIG. 9 is a flow diagram of a method of constructing an involuntary guidance and transport system for fish in accordance with one embodiment.

FIG. 10 is a flow diagram of a method of using an involuntary guidance and transport system for fish in accordance with one embodiment.

### DETAILED DESCRIPTION OF ILLUSTRATIVE EMBODIMENTS

Embodiments described below provide an efficient means for removing migrating fish from a waterway without killing the fish.

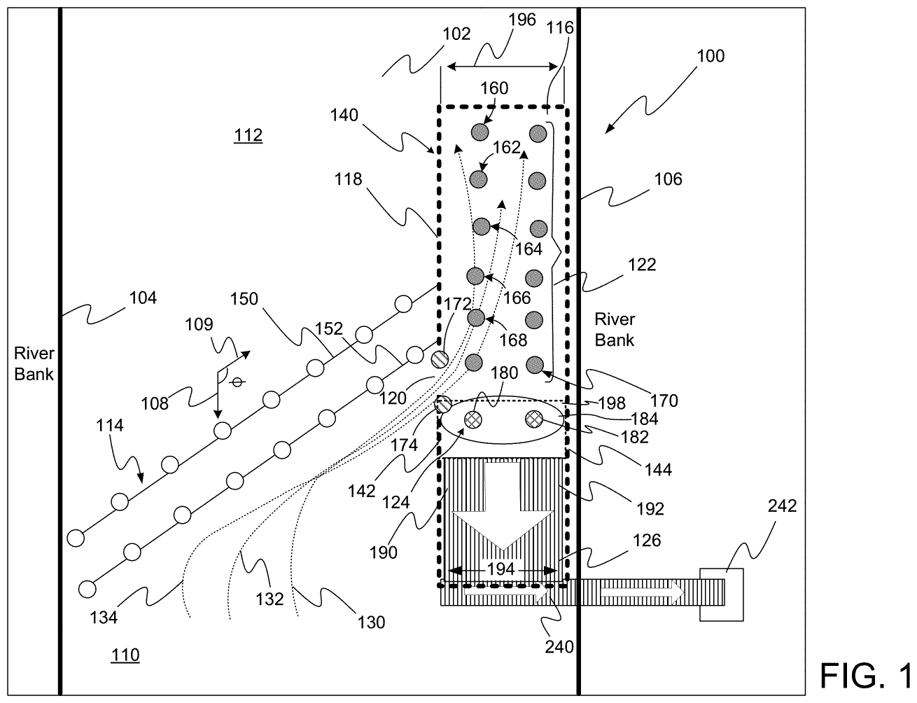

FIG. 1 provides a system 100 for removing migrating fish from a waterway 102, such as a river or stream. Waterway 102 is defined between two riverbanks 104 and 106 through which a water current flows in a direction 108. During migration, different species of fish will migrate along waterway 102 by swimming against the direction of water flow 108 from a downstream position 110 toward an upstream position 112.

System 100 includes a barrier 114 positioned in river 102 along a direction 109 at an angle θ relative to the flow direction 108 of waterway 102 where θ is generally greater than 90° and less than 180°. Migrating fish generally swim against flow direction 108. When a migrating fish reaches barrier 114, the fish is unable to swim through barrier 114 and as a result, the fish's efforts to continue moving upstream against flow direction 108 cause the fish to move upstream along barrier 114 as shown generally by fish paths 130, 132 and 134.

In accordance with some embodiments, barrier 114 is a physical fence made for example from poly-vinyl chloride (PVC) posts or stakes that are connected together by lateral supports to provide a space between each post that allows water to flow through the posts but prevents migrating fish from passing between the posts. In other embodiments, barrier 114 is an electrical barrier or a guidance/deterrence system consisting of one or more suspended electrodes along the barrier. In other embodiments, barrier 114 could be an electric barrier placed on the bottom of the stream. In other embodiments, barrier 114 is an acoustic or light guidance/deterrence system. In FIG. 1, the barrier consists of two parallel chains of electrodes 150 and 152 that develop an electric field between the chains such that the electric field increases in intensity closer to chain 150.

Barrier 114 leads the migrating fish to a gate 120 in a fence 118 that defines a holding area 116. Fence 118 includes a holding portion 140 that defines an upstream portion of holding area 116. After migrating fish pass through gate 120, they continue to swim upstream until they are stopped by holding portion 140 of fence 118. The fish continue to swim against the current at this position and thus remain in the upstream portion of holding area 116. In accordance with one embodiment, fence 118 is a physical barrier constructed of spaced-apart posts that extend from the bottom of the waterway to above the waterline. The spaced-apart posts are connected together by lateral supports so that there is enough space between the posts to allow the water current to pass through fence 118 while preventing the migrating fish from passing through fence 118. In accordance with some embodiments, fence 118 is made of PVC.

Holding area 116 includes a crowding device 122, a fish stunning device 124, and a conveyor 126. Fish stunning device 124 is located downstream of crowding device 122 and at least a portion of conveyor 126 is located relative to stunning device 124 such that stunned fish are carried by a current to conveyor 126. In system 100, crowding device 122 consists of rows of electrodes, such as rows 160, 162, 164, 166, 168 and 170. The rows of electrodes are capable of being independently energized to generate an electric field between the electrodes in a row-by-row fashion. By sequentially energizing the rows of electrodes starting from the furthest upstream row 160 and ending with the furthest downstream row 170, it is possible to direct the fish downstream thereby crowding the fish around the stunning device 124. Specifically, when a row of electrodes is activated, fish that are within the electric field generated by the electrodes will be irritated by the electric field and will swim downstream until they are outside of the electric field. This will place the fish in the area around the next row of electrodes, which are then activated thereby causing the fish to swim further downstream. When a row of electrodes is activated, it may remain activated so that eventually all of the rows of electrodes are energized at the same time or the row may be deactivated a short time after the row downstream from the row is energized so that only one or two rows of electrodes are energized at the same time.

To prevent the fish from exiting holding area 116 during this crowding, gate 120 is closed before crowding device 122 is activated. In accordance with one embodiment, gate 120 consists of two electrodes 172 and 174 that are energized to close gate 120 and are de-energized to open gate 120. In other embodiments, gate 120 can be a physical movable gate that can move vertically out of the waterway, pivot laterally on a hinge, or slide laterally within the waterway, for example.

Stunning device 124, also referred to as fish stunner 124, consists of two or more electrodes such as electrodes 180 and 182 that are de-energized until fish have been crowded around stunning device 124 by crowding device 122 and then are energized to generate an electric field that stuns fish in a stunning zone 184. Although fixed electrodes are shown in the Figures, stunning device 124 can also be implemented using portable electrodes such as a backpack electrofisher or a floating vessel (e.g. boat) with electrodes. In accordance with one embodiment, stunning zone 184 is a volume of water that extends from the top surface of the water to the bottom of the waterway and that extends both upstream and downstream of electrodes 180 and 182. In accordance with one embodiment, at least a portion of conveyor 126 is located relative to the stunning zone 184 such that stunned fish will drift with a current from stunning zone 184 to conveyor 126. In accordance with one embodiment, electrodes 180 and 182 only need to be momentarily energized in order to stun the fish and once the fish are stunned, the electrodes 180 and 182 are turned off. Once stunned, the fish are temporarily unable to swim but are still alive. Because they are unable to swim, the stunned fish drift with the current, which can be the natural current of waterway 102 or an artificial current generated by one or more pumps.

A stunned fish cannot be controlled using electrodes because the fish is unable to swim away from an electric field. In order to ensure that each stunned fish comes into contact with conveyor 126, a set of physical guides are placed in the waterway that extend from the sides and bottom of conveyor 126 in an upstream direction past stunning device 124. Such physical guides physically restrain where the fish can drift to as opposed to electric field guides that use electric fields to guide the fish. In some embodiments, the physical guides extending from the sides of conveyor 126 are constructed of spaced-apart posts that extend from the bottom of the waterway to above the waterline and the guide at the bottom of the conveyor is a board or a metal surface. The spaced-apart posts are connected together by lateral supports that maintain the spacing between the posts to allow the water current to flow through the physical guides while preventing fish larger than a threshold size from passing through the guides. The spacing between the posts is selected to prevent the targeted migrating fish from passing through the guides after the fish have been stunned while allowing smaller fish to pass through the guides. In the embodiment of FIG. 1, the physical guides are formed from conveyor guide portions 142 and 144 of fence 118, which extend upstream from sides 190 and 192 of conveyor 126 to a position that is upstream from electrodes 180 and 182.

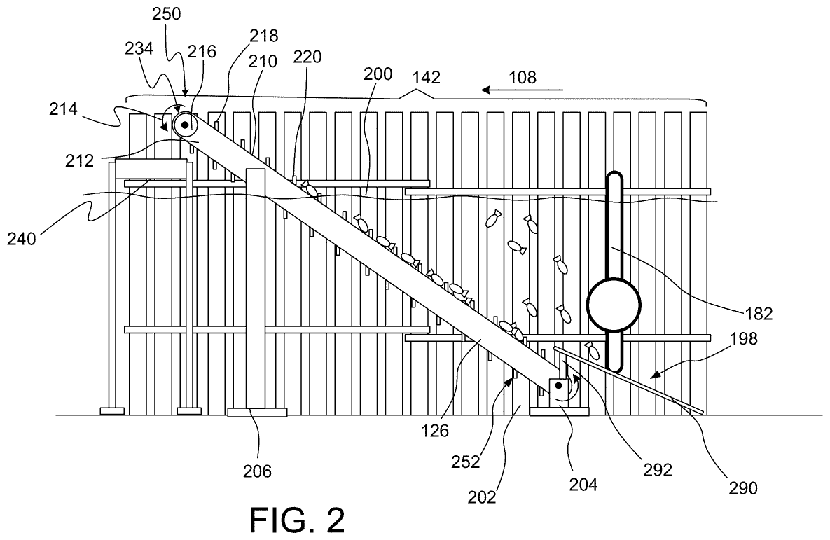

FIG. 2 provides a side view of a portion of system 100 showing conveyor 126, stunning electrode 182 and conveyor guide portion 142 and a bottom guide 198. Conveyor 126 is supported on a bottom 202 of the waterway by supports 204 and 206 which support a frame 212 of conveyor 126. Frame 212 in turn supports a belt 210 and an electric motor 216. Frame 212 and belt 210 are at an angle to a top surface 200 of waterway 102 such that an upstream portion 252 of frame 212 and belt 210 is below the waterline marked by top surface 200 and a downstream portion 250 of frame 212 and belt 210 is above the waterline marked by top surface 200. In accordance with the embodiment of FIG. 2, upstream portion 252 of frame 212 and belt 210 are positioned near a bottom 202 of waterway 102. Bottom guide 198 is a board 290 supported by legs 292 or frame 212, which in turn are supported by support 204.

Motor 216 is rotatably engaged with belt 210 such that when motor 216 is on and rotating, motor 216 rotates belt 210 around frame 212 in a direction 214. Belt 210 includes a plurality of supports, such as supports 218 and 220, which extend away from the surface of belt 210 so as to provide a surface for supporting fish as they are conveyed from waterway 102 to a top end 234 of conveyor 126. Belt 210 has a width 194 that extends from side 190 to side 192 between guide portions 142 and 144 such that any gap between belt 210 and guide portions 142 and 144 is small enough to prevent a stunned fish from passing through the gap. As shown in FIG. 2, guide portions 142 and 144 extend from top end 234 of conveyor 126 to a position upstream of stunning electrode 182. In accordance with one embodiment, guide portions 142 and 144 extend to an upstream end of stunning zone 184 to ensure that all stunned fish drift onto conveyor 126 due to the flow of water in direction 108. Bottom guide 198 has a downstream end that is above the upstream end of conveyor 126 and an upstream end that rests on bottom 202 of the waterway. Bottom guide 198 prevents fish from swimming or drifting below conveyor 126.

As belt 210 rotates around conveyor 126, drifting stunned fish in waterway 102 contact belt 210 and the supports of belt 210, such as supports 218 and 220, and are transported along conveyor 126 by belt 210 to end 234 of conveyor 126. When the fish reach end 234, they drop from end 234 onto a lateral conveyor or slide 240, which conveys the stunned fish to a receptacle or transport vehicle 242 located on the riverbank. The stunned fish can then be transported to another part of the waterway or can be sorted to remove invasive species before returning non-invasive species to the water.

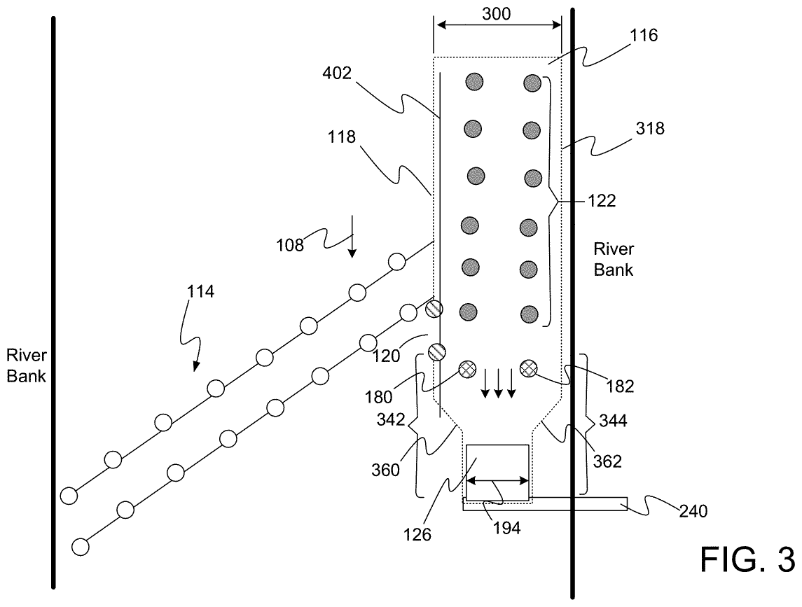

In FIG. 1, the width 196 of upstream portion 140 of holding area 116 is shown to be substantially the same as width 194 of conveyor 126. FIG. 3 provides an alternative embodiment in which the width 300 of holding area 116 is wider than width 194 of conveyor 126. To achieve this, the fence 318 that defines holding area 116 in FIG. 3 includes guide portions 342 and 344 that extend from sides 190 and 192 of conveyor 126 to a position upstream from stunning devices 180 and 182 and include two angled portions 360 and 362 that narrow holding area 116 from width 300 to width 194. In accordance with one embodiment, the angle of angled portions 360 and 360 to flow direction 108 is selected to ensure that drifting stunned fish will be guided to conveyor 126 and will not become trapped against angled portions 360 and 362.

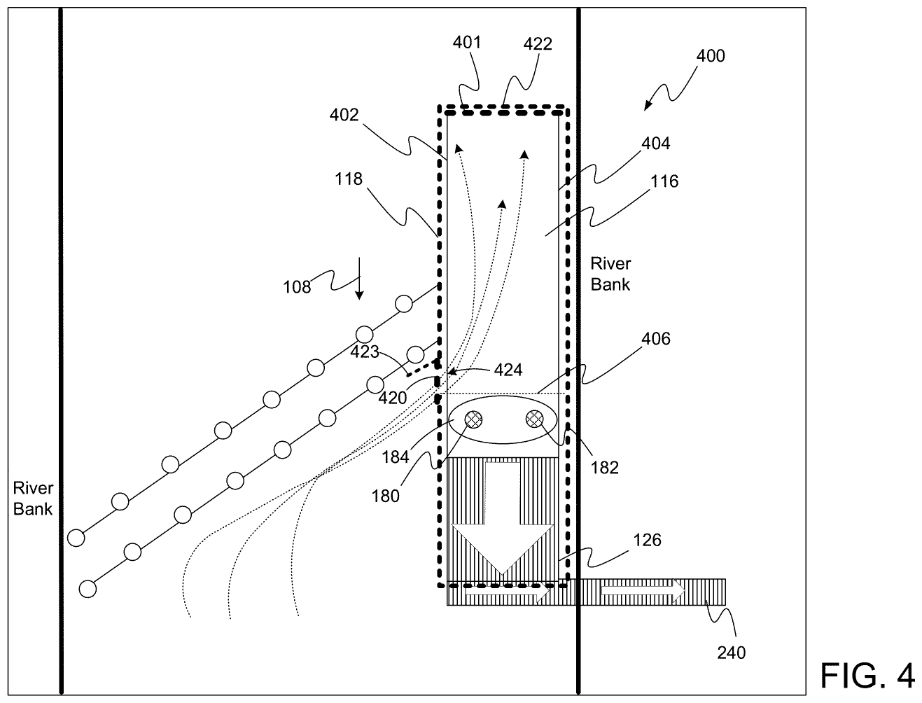

FIG. 4 provides an alternative embodiment showing a system 400, which is identical to system 100 of FIG. 1 except for including a different crowding device 422. In FIG. 4, instead of using electrodes to form the crowding device, a crowding device 422 is provided that includes a movable fence 401 that moves along two guides 402 and 404. As fence 401 is moved in a downstream direction 108, fish in holding portion 140 are guided downstream toward stunning zone 184. When movable fence 401 reaches a position 406, stunning electrodes 180 and 182 are energized thereby stunning but not killing the fish, which then drift onto conveyor 126. In FIG. 4, instead of using electrodes 172 and 174 for gate 120, system 400 uses a physical gate 420, which can either be in an opened position 423 to allow fish to enter holding area 116 or a closed position 424, to prevent fish from exiting holding area 116 while moving movable fence 401 downstream. In accordance with a further alternative embodiment, crowding device 422 includes a floating platform instead of fence 401. The floating platform has a row of electrodes attached to it and can be pulled downstream to guide fish in holding portion 140 toward stunning zone 184 and can be pulled upstream to provide a space in holding portion 140 for more fish.

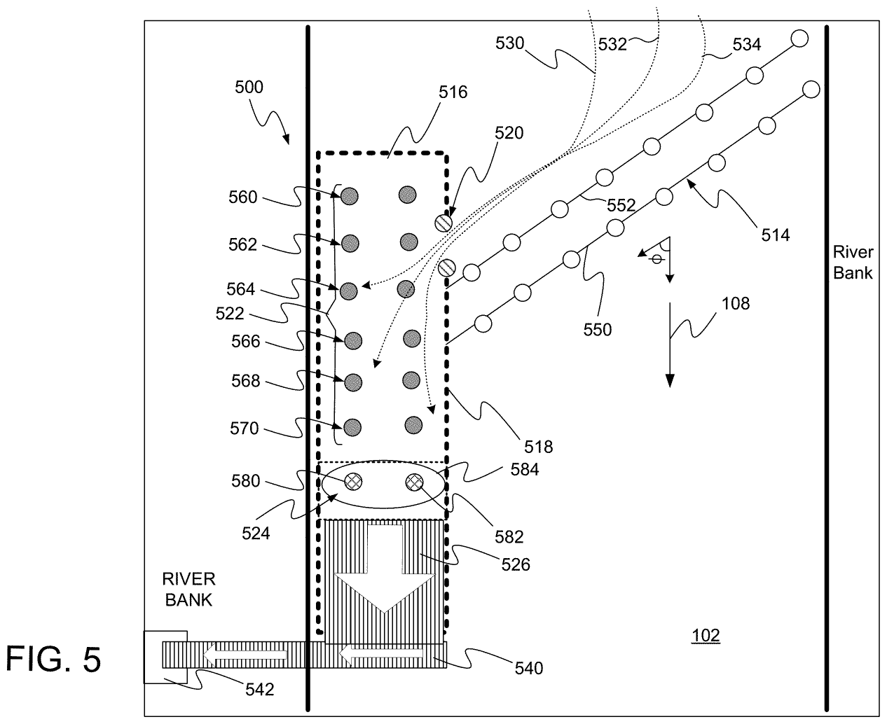

FIG. 5 provides another system 500 for removing migrating fish from waterway 102 when the fish are migrating downstream in the direction of water flow 108.

System 500 includes a barrier 514 positioned in river 102 at an angle θ relative to the flow direction 108 of waterway 102 where θ is generally less than 90. When a migrating fish reaches barrier 514, the fish is unable to swim through barrier 514 and as a result, the fish's efforts to continue moving downstream cause the fish to move downstream along barrier 514 as shown generally by fish paths 530, 532 and 534.

In accordance with some embodiments, barrier 514 is a physical fence made for example from poly-vinyl chloride (PVC) posts or stakes that are connected together by lateral supports to provide a space between each post that allows water to flow through the posts but prevents migrating fish from passing between the posts. In other embodiments, barrier 514 is an electrical barrier or a guidance/deterrence system consisting of one or more suspended electrodes along the barrier. In other embodiments, barrier 514 could be an electric barrier placed on the bottom of the stream. In other embodiments, barrier 514 is an acoustic or light guidance/deterrence system. In FIG. 5, the barrier consists of two parallel chains of electrodes 550 and 552 that develop an electric field between the chains such that the electric field increases in intensity closer to chain 550.

Barrier 514 leads the migrating fish to a gate 520 in a fence 518 that defines a holding area 516. In accordance with one embodiment, fence 518 is a physical barrier constructed of spaced-apart posts that extend from the bottom of the waterway to above the waterline. The spaced-apart posts are connected together by lateral supports so that there is enough space between the posts to allow the water current to pass through fence 518 while preventing the migrating fish from passing through fence 518. In accordance with some embodiments, fence 518 is made of PVC.

Holding area 516 includes a crowding device 522, a fish stunning device 524, and conveyor 526. Fish stunning device 524 is located downstream of crowding device 522 and at least a portion of conveyor 526 is located downstream from fish stunning device 524. In system 500, crowding device 522 consists of rows of electrodes, such as rows 560, 562, 564, 566, 568 and 570. The rows of electrodes are capable of being independently energized to generate an electric field between the electrodes in a row-by-row fashion. By sequentially energizing the rows of electrodes starting from the furthest upstream row 560 and ending with the furthest downstream row 570, it is possible to direct the fish downstream thereby crowding the fish around stunning device 524. Specifically, when a row of electrodes is activated, fish that are within the electric field generated by the electrodes will be irritated by the electric field and will swim downstream until they are outside of the electric field. This will place the fish in the area around the next row of electrodes, which are then activated thereby causing the fish to swim further downstream. When a row of electrodes is activated, it may remain activated so that eventually all of the rows of electrodes are energized at the same time or the row may be deactivated a short time after the row downstream from the row is energized so that only one or two rows of electrodes are energized at the same time.

To prevent the fish from exiting holding area 516 during this crowding, gate 520 is closed before crowding device 522 is activated. In accordance with one embodiment, gate 520 consists of two electrodes that are energized to close gate 520 and are de-energized to open gate 520. In other embodiments, gate 520 can be a physical movable gate that can move vertically out of the waterway, pivot laterally on a hinge, or slide laterally within the waterway, for example.

Stunning device 524, also referred to as fish stunner 524, consists of at least two electrodes, such as electrodes 580 and 582, that are de-energized until fish have been crowded around stunning device 524 by crowding device 522 and then are energized to generate an electric field that stuns fish in a stunning zone 584. In accordance with one embodiment, stunning zone 584 is a volume of water that extends from the top surface of the water to the bottom of the waterway and that extends both upstream and downstream of the electrodes that form fish stunner 524. In accordance with one embodiment, at least a portion of conveyor 526 is located downstream from stunning zone 584. In accordance with one embodiment, the electrodes of fish stunner 524 only need to be momentarily energized in order to stun the fish and once the fish are stunned, the electrodes are turned off. Once stunned, the fish are temporarily unable to swim but are still alive. Because they are unable to swim, the stunned fish drift with the current of the waterway, which can be the natural current of the waterway or an artificially generated current formed by one or more pumps.

A stunned fish cannot be controlled using electrodes because the fish is unable to swim away from an electric field. In order to ensure that each stunned fish comes into contact with conveyor 526, a set of physical guides are placed in the waterway that extend from the sides and bottom of conveyor 526 in an upstream direction past stunning device 524. Such physical guides physically restrain where the fish can drift to as opposed to electric field guides that use electric fields to guide the fish. In some embodiments, the physical guides are constructed of spaced-apart posts that extend from the bottom of the waterway to above the waterline. The spaced-apart posts are connected together by lateral supports that maintain the spacing between the posts to allow the water current to flow through the physical guides while preventing fish larger than a threshold size from passing through the guides. The spacing between the posts is selected to prevent the targeted migrating fish from passing through the guides after the fish have been stunned while allowing smaller fish to pass through the guides.

Conveyor 526 has the same structure and operates in the same manner as conveyor 126. After fish stunner 524 has been activated, a motor on conveyor 526 is turned on causing a belt to rotate around conveyor 526. Drifting stunned fish in waterway 102 contact the belt and supports of the belt and are transported along conveyor 526 to an end of conveyor 526. When the fish reach the end of conveyor 526, they drop from the end onto a lateral conveyor or slide 540, which conveys the stunned fish to a receptacle or transport vehicle 542 located on the riverbank. The stunned fish can then be transported to another part of the waterway or can be sorted to remove invasive species before returning non-invasive species to the water.

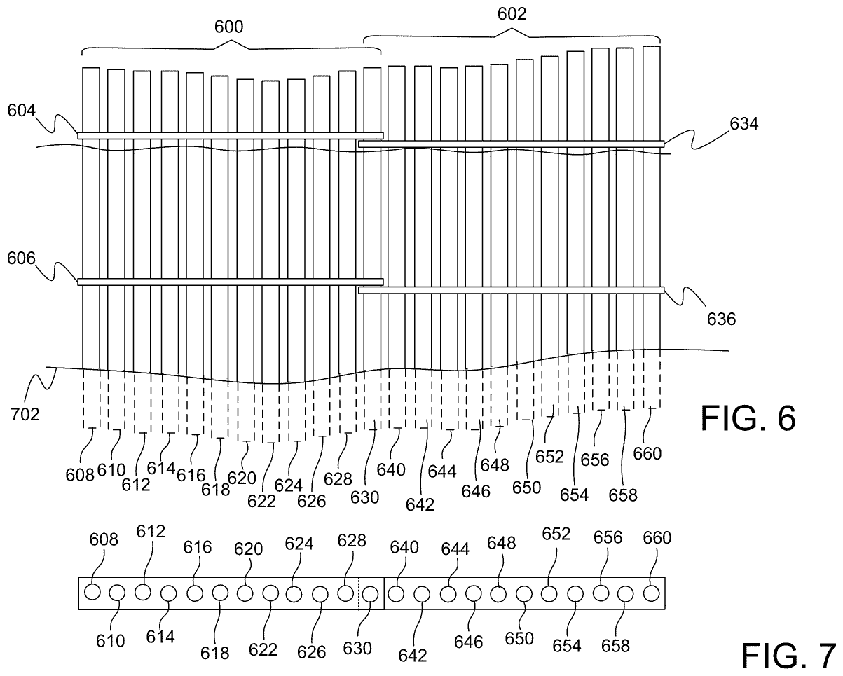

FIG. 6 provides a side view and FIG. 7 provides a top view of two sections 600 and 602 of fence 118 that can also be used as physical guides. Section 600 consists of lateral supports 604 and 606 and hollow posts 608, 610, 612, 614, 616. 618, 620, 622, 624, 626, 628 and 630, which pass through respective holes in lateral supports 604 and 606. Section 602 consists of lateral supports 634 and 636 and hollow posts 630, 640, 642, 644, 646, 648, 650, 652, 654, 656, 658, and 660, which pass through respective holes in lateral supports 634 and 636. Note that hollow post 630 is part of both section 600 and section 602 and passes through respective holes in lateral supports 604, 606, 634 and 636.

During installation, sections of the fence are first formed by inserting hollow posts in each of the holes of the two lateral supports of the section with the exception of the holes at the ends of the lateral supports. In accordance with one embodiment, the holes of the lateral supports are sized relative to the hollow posts such that the hollow posts are held in place in the lateral supports by friction. A section of the fence is then taken to its desired position in the waterway and two or more of the hollow posts in the section are driven into the bottom 202 of the waterway so that they become embedded in the waterway as indicated by the dotted lines of FIG. 6. This temporarily secures the section in the waterway. The next section in the fence is then placed in a desired position in the waterway. This position is such that the holes at the ends of the lateral supports of the two sections overlap. A hollow post is then inserted through the four lateral supports to connect the two sections together. Two or more of the hollow posts of the new section are then driven into bottom 202 of the waterway. This section-by-section construction continues until the fence is complete. Any hollow posts that have yet to be driven into bottom 202 are then driven into bottom 202 to firmly secure fence 118 to bottom 202.

Because of the spacing between the hollow posts, water can flow between the posts while the sections are being moved into position. This makes it easier to move the sections than if the sections were made of solid walls. In addition, because the hollow posts can be independently driven into bottom 202, each post can be driven a different amount so as to accommodate unevenness in bottom 202. In addition, because the hollow posts can be independently driven into bottom 202, if scouring occurs underneath any of the posts, these posts can be driven further into the sediment without the need to readjust the entire panel, which would be the case of posts were attached to lateral supports by means other than friction. This makes installation and maintenance much more practical than if the posts were attached to lateral supports by means other than friction.

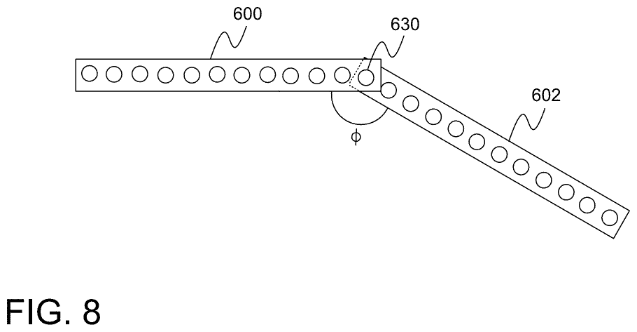

As shown in the top view of FIG. 8, sections 600 and 602 can be placed at any desired angle, Φ, relative to each other by pivoting the sections around hollow post 630.

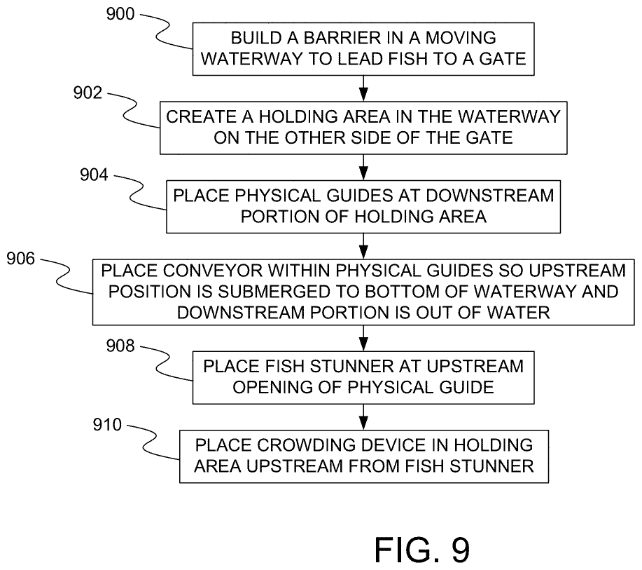

FIG. 9 provides a method of constructing a fish collection system in accordance with one embodiment. In step 900, a barrier is constructed in a moving waterway to lead fish to a gate. At step 902, a holding area is created in the waterway on the other side of the gate. At step 904, physical guides are placed at the downstream portion of the holding area and at step 906, a conveyor is placed within the physical guide so an upstream portion of the conveyor is submerged to the bottom of the waterway and a downstream portion of the conveyor is out of the water. At step 908, fish stunners are placed just downstream of the upstream opening of the physical guide and at 910, a crowding device is placed in the holding area upstream from the fish stunners. Although the steps of FIG. 9 are shown in one order, those skilled in the art will recognize that the steps may be performed in any desired order.

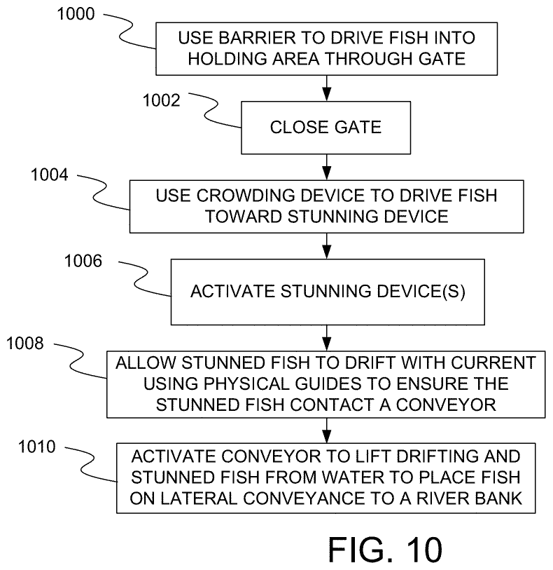

FIG. 10 provides a flow diagram of a method of collecting fish. In step 1000 of FIG. 10, a barrier is used to drive fish into a holding area through a gate. At step 1002, the gate is closed and at step 1004, a crowding device is used to drive fish within the holding area toward one or more stunning devices. At step 1006, the stunning devices are activated. At step 1008, the stunned fish are allowed to drift with the current of the waterway using physical guides to ensure the stunned fish contact a conveyor. At step 1010, the conveyor is activated to lift the drifting and stunned fish from the water as the water current brings the fish into contact with the conveyor and to place the fish on a lateral conveyance to a riverbank. In accordance with one embodiment, the belt is stationary while the crowding device is activated and immediately before the stunning device is activated to prevent actively swimming fish from being lifted by the conveyor. This helps to prevent fish from jumping off the conveyor and back into the waterway.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A system comprising:
a fish stunner configured to stun fish within a stunning zone of a waterway; and
a conveyor with a portion of the conveyor located below a waterline of the waterway and a second portion of the conveyor located above the waterline such that fish that have been stunned reach the conveyor and are lifted out of the water by the conveyor.

2. The system of claim 1 further comprising at least one physical guide for guiding fish that have been stunned in the stunning zone to increase a likelihood that a stunned fish drifts onto the conveyor.

3. The system of claim 1 further comprising a fish holding area having a gate.

4. The system of claim 3 wherein the fish holding area is upstream of the stunning zone.

5. The system of claim 3 further comprising a fish crowding device configured to direct fish swimming in the fish holding area toward the stunning zone when the fish crowding device is activated.

6. The system of claim 5 wherein the gate is configured to be closed to prevent fish from exiting the fish holding area when the crowding device is activated.

7. The system of claim 6 wherein the conveyor is configured to not convey fish while the fish crowding device is activated and is further configured to convey fish after the stunner has stunned fish in the stunning zone.

8. A method comprising:
activating a fish stunner in a waterway to produce stunned and drifting fish;
directing the stunned and drifting fish onto a conveyor that is at least partially in the waterway; and
using the conveyor to lift stunned fish out of the waterway.

9. The method of claim 8 further comprising, before activating the fish stunner, crowding fish into a stunning zone around the fish stunner.

10. The method of claim 9 wherein crowding the fish into the stunning zone comprises:
guiding the fish into a holding area through a gate;
closing the gate; and
directing the fish in the holding area into the stunning zone.

11. The method of claim 10 wherein directing the fish in the holding area into the stunning zone comprises directing the fish downstream.

12. A system comprising:
a fish holding area located in a waterway;
a stunning device located in the waterway; and
a conveyor located relative to the stunning device such that stunned fish move with a current onto the conveyor.

13. The system of claim 12 wherein the fish holding area comprises a fence.

14. The system of claim 13 wherein the fence comprises a gate.

15. The system of claim 14 further comprising a fish crowding device.

16. The system of claim 15 wherein when activated, the fish crowding device moves swimming fish toward the stunning device.

17. The system of claim 12 wherein the current comprises an artificial current created by a pump.

18. The system of claim 12 wherein the current comprises a natural current of the waterway.

19. A fence for a waterway, the fence comprising:
a first lateral support having a plurality of holes;
a second lateral support having a plurality of holes; and
a plurality of posts, each post passing through a respective hole of the plurality of holes of the first lateral support and a respective hole of the plurality of holes of the second lateral support such that each post moves through the post's respective holes independently of other posts of the plurality of posts.

20. The fence of claim 19 wherein the first lateral support, the second lateral support and the plurality of posts form a first section of the fence and the fence further comprises
a second section comprising:
a third lateral support having a plurality of holes;
a fourth lateral support having a plurality of holes; and
a plurality of posts, each post passing through a respective hole of the plurality of holes of the third lateral support and a respective hole of the plurality of holes of the fourth lateral support such that each post moves through the post's respective holes independently of other posts of the plurality of posts.

21. The fence of claim 20 wherein one post passes through respective holes of the first lateral support, the second lateral support, the third lateral support and the fourth lateral support.
